(19) United States
(12) Patent Application Publication
(10) Pub. No.: US 2022/0404593 A1
(43) Pub. Date: Dec. 22, 2022

(54) ADJUSTABLE TELECONVERTER SYSTEMS AND METHODS

(71) Applicant: Teledyne FLIR Commercial Systems, Inc., Goleta, CA (US)

(72) Inventors: Gu Hong Zhang, Acton, MA (US); Gregory Fitzgerald, Marlborough, MA (US)

(21) Appl. No.: 17/841,338

(22) Filed: Jun. 15, 2022

Related U.S. Application Data
(60) Provisional application No. 63/211,454, filed on Jun. 16, 2021.

(51) Int. Cl. G02B 13/00; G02B 13/22

(52) U.S. Cl. CPC G02B 13/0095; G02B 13/22

(57) ABSTRACT

An adjustable teleconverter is provided that may be selectively adjusted between a base lens configuration and one or more tele-lens configurations without adding, removing, or replacing lenses from an optical system. In one example, a system includes a front lens group configured to form a first image at an intermediate image plane in response to radiation from a scene. The system also includes a teleconverter configured to project the first image to form a second image at a final image plane. The teleconverter comprises a relay lens group configured to be selectively positioned between the intermediate image plane and the final image plane to adjust a magnification of the second image. Additional methods, devices, and systems are also provided.

### CROSS REFERENCE TO RELATED APPLICATIONS

This application claims priority to and the benefit of U.S. Provisional Patent Application No. 63/211,454 filed Jun. 16, 2021 and entitled “ADJUSTABLE TELECONVERTER SYSTEMS AND METHODS,” which is herein incorporated by reference in its entirety.

### TECHNICAL FIELD

The present invention relates generally to optical systems and, more particularly, to teleconverters for use in image capture.

### BACKGROUND

In the field of image capture, various lenses are often used to provide different focal lengths to capture images with desired fields of view. For example, in some cases, a telephoto lens (e.g., a fixed or zoom telephoto lens) may replace a base lens (e.g., a lens providing an original or native focal length) to extend or multiply the local length of an optical system. In other cases, a teleconverter (e.g., also referred to as a tele-extender) may be used in combination with an existing base lens to similarly increase the focal length, but at potentially less cost and weight in comparison to a telephoto lens.

In some cases, the teleconverter may be positioned in front, between, or behind one or more base lenses of the optical system. However, this is often impractical. For example, in thermal imaging systems where an image sensor is disposed in a dewar, it may not be possible to add a teleconverter behind the base lens. In other cases, size or space limitations may restrict the practical addition of a teleconverter to an existing optical system.

### SUMMARY

In accordance with embodiments discussed herein, an adjustable teleconverter may be selectively adjusted between a base lens configuration and one or more tele-lens configurations without adding, removing, or replacing lenses from an optical system. For example, the teleconverter may operate as a relay group (e.g., an individual relay lens or multiple relay lenses) of an optical system to pass an intermediate image provided by a front lens group (e.g., implemented by an objective lens and/or a zoom lens) to an imager.

By implementing the teleconverter in a variable manner as discussed herein (e.g., also in combination with receiving an intermediate image from a zoom group of lenses in some embodiments as discussed), a larger magnification range may be provided without substantially increasing size or space requirements of the optical system.

In one embodiment, a system includes a front lens group configured to form a first image at an intermediate image plane in response to radiation from a scene; a teleconverter configured to project the first image to form a second image at a final image plane; and wherein the teleconverter comprises a relay lens group configured to be selectively positioned between the intermediate image plane and the final image plane to adjust a magnification of the second image.

In another embodiment, a method includes forming, by a front lens group, a first image at an intermediate image plane in response to radiation from a scene; projecting, by a teleconverter, the first image to form a second image at a final image plane; and selectively positioning a relay lens group of the teleconverter between the intermediate image plane and the final image plane to adjust a magnification of the second image.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an imaging system in accordance with an embodiment of the disclosure.

FIG. 2 illustrates a block diagram of an optical system including a teleconverter in combination with other features in accordance with an embodiment of the disclosure.

FIG. 3 illustrates a teleconverter with a single lens in a base configuration in accordance with an embodiment of the disclosure.

FIG. 4 illustrates a teleconverter with a single lens in a magnified configuration in accordance with an embodiment of the disclosure.

FIG. 5 illustrates an example implementation of the teleconverter of FIG. 3 in an optical system accordance with an embodiment of the disclosure.

FIG. 6 illustrates an example implementation of the teleconverter of FIG. 4 in an optical system in accordance with an embodiment of the disclosure.

FIG. 7 illustrates a teleconverter with multiple lenses in a base configuration in accordance with an embodiment of the disclosure.

FIG. 8 illustrates a teleconverter with multiple lenses in a magnified configuration in accordance with an embodiment of the disclosure.

FIG. 9 illustrates an example implementation of the teleconverter of FIG. 7 in an optical system in accordance with an embodiment of the disclosure.

FIG. 10 illustrates an example implementation of the teleconverter of FIG. 8 in an optical system in accordance with an embodiment of the disclosure.

FIG. 11 illustrates a process of operating an imaging system with a teleconverter in accordance with an embodiment of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

In optical systems employing re-imaging techniques, an image is formed in two main operations. First, a front lens group (e.g., including an objective lens and/or a zoom lens group) receive radiation (e.g., visible light, thermal radiation, and/or other wavelengths) from a scene and form an intermediate image of the scene at an intermediate image plane. Second, the intermediate image is received by a relay lens group (e.g., provided by a teleconverter of the present disclosure) that projects the intermediate image to a final image plane that is captured by an imager.

Such re-imaging techniques may be advantageously applied, for example, in thermal imaging systems having a cooled detector and a cold shield. In this regard, such re-imaging techniques may advantageously reduce the size of lenses that would otherwise be required in the front lens group by imaging the cold stop.

The magnification of optical systems employing such re-imaging techniques may be determined by the product of the magnification of the front lens group with the magnification of the relay lens group. Thus, by changing the magnification of the relay lens group, the overall system magnification may be selectively adjusted.

For example, in accordance with various embodiments provided herein, a relay lens group implemented by an adjustable teleconverter includes one or more lenses that may be selectively positioned along an optical axis of an optical system. As a result, the magnification provided by the relay lens group and therefore the optical system as a whole may be selectively adjusted.

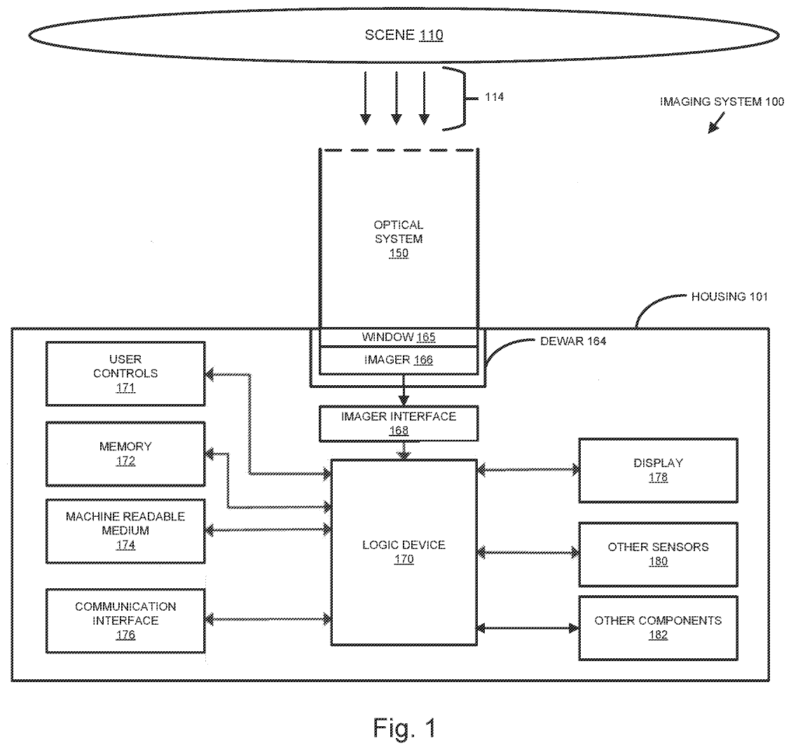

Turning now to the drawings, FIG. 1 illustrates a block diagram of an imaging system 100 in accordance with an embodiment of the disclosure. As shown, imaging system 100 includes an optical system 150, a housing 101 (e.g., a camera body), a dewar 164, a transmissive window 165, an imager 166, an imager interface 168, a logic device 170, user controls 171, a memory 172, a machine readable medium 174, a communication interface 176, a display 178, other sensors 180, and other components 182.

In various embodiments, imaging system 100 (e.g., an imaging device) may be implemented, for example, as a camera system such as a portable (e.g., handheld) camera system, a small form factor camera system implemented as part of another device, a fixed camera system, and/or other appropriate implementations. Imaging system 100 may be positioned to receive electromagnetic radiation 114 of various wavelengths from a scene 110 (e.g., a field of view of imaging system 100). In various embodiments, scene 110 may include various features of interest such as one or more persons, objects, and/or other features.

Radiation 114 is received and focused by optical system 150 which may include various optical elements (e.g., lenses, filters, and/or other components) as appropriate. For example, optical system 150 may include an adjustable teleconverter as further discussed herein. Radiation 114 passed by optical system 150 is received through window 165 to be captured by imager 166. Thus, it will be appreciated that various components of optical system 150 may operate to selectively filter out portions of radiation 114 such that only desired wavelengths and/or desired radiation intensities are ultimately received by imager 166. For example, various coatings may be provided on lenses or dedicated filter elements may be provided to filter visible light wavelengths, infrared wavelengths, thermal wavelengths, and/or others. In various embodiments, any desired combination of such components may be provided (e.g., various components may be included and/or omitted as appropriate for various implementations).

Imager 166 captures images of scene 110 in response to radiation 114. Imager 166 may include an array of sensors for capturing images (e.g., image frames) of scene 110. In some embodiments, imager 166 may also include one or more analog-to-digital converters for converting analog signals captured by the sensors into digital data (e.g., pixel values) to provide the captured images. Imager 166 will be primarily described herein as a thermal imager configured to capture thermal wavelengths. It will be appreciated that imagers associated with other wavelengths are also contemplated where appropriate.

Imager 166 may be deployed in dewar 164 implemented, for example, as an integrated dewar cooler assembly (IDCA) providing an interior volume sealed by window 165 and the imager 166 disposed within the interior volume. In some embodiments, IDCA may include a cryocooler to maintain imager 166 at a specified low temperature (e.g., 77 K in some embodiments where imager 166 is implemented by an InSb focal plane array). In some embodiments, a filter may be deployed in the IDCA and thus also maintained at the low temperature (e.g., also referred to as a “cold filter”).

Imager interface 168 provides the captured images to logic device 170 which may be used to process the images, store the received and/or processed images in memory 172, and/or retrieve stored images from memory 172.

Although a single imager 166 is illustrated, a plurality of imagers 166 and associated components may be provided in other embodiments. For example, different imagers 166 may be provided to capture the same or different wavelengths of radiation 114 simultaneously to provide associated captured images in some embodiments.

Logic device 170 may include, for example, a programmable logic device such as a field programmable gate array (FPGA), a microprocessor, a single-core processor, a multi-core processor, a microcontroller, a graphics processing unit (GPU), a reduced instruction set computer (RISC) processor, a programmable logic device configured to perform processing operations, a digital signal processing (DSP) device, one or more memories for storing executable instructions (e.g., software, firmware, or other instructions), and/or any other appropriate combinations of devices and/or memory to perform any of the various operations described herein. Logic device 170 is configured to interface and communicate with the various components of imaging system 100 to perform various method and processing steps described herein. In various embodiments, processing instructions may be integrated in software and/or hardware as part of logic device 170, or code (e.g., software and/or configuration data) which may be stored in memory 172 and/or a machine readable medium 174. In various embodiments, the instructions stored in memory 172 and/or machine readable medium 174 permit logic device 170 to perform the various operations discussed herein and/or control various components of imaging system 100 for such operations.

Memory 172 may include one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, fixed memory, removable memory, and/or other types of memory. In some embodiments, portions of memory 172 may be included in logic device 170 (e.g., block memory of an FPGA used to implement logic device 170) to provide various buffers and/or other memory storage as appropriate.

Machine readable medium 174 (e.g., a memory, a hard drive, a compact disk, a digital video disk, or a flash memory) may be a non-transitory machine readable medium storing instructions for execution by logic device 170. In various embodiments, machine readable medium 174 may be included as part of imaging system 100 and/or separate from imaging system 100, with stored instructions provided to imaging system 100 by coupling the machine readable medium 174 to imaging system 100 and/or by imaging system 100 downloading (e.g., via a wired or wireless link) the instructions from the machine readable medium (e.g., containing the non-transitory information).

Logic device 170 may be configured to process captured images and provide them to display 178 for presentation to and viewing by the user. Display 178 may include a display device such as a liquid crystal display (LCD), an organic light-emitting diode (OLED) display, and/or other types of displays as appropriate to display images and/or information to the user of imaging system 100. Logic device 170 may be configured to display images and information on display 178. For example, logic device 170 may be configured to retrieve images and information from memory 172 and provide images and information to display 178 for presentation to the user of imaging system 100. Display 178 may include display electronics, which may be utilized by logic device 170 to display such images and information.

User controls 171 may include any desired type of user input and/or interface device having one or more user actuated components, such as one or more buttons, slide bars, knobs, keyboards, joysticks, and/or other types of controls that are configured to generate one or more user actuated input control signals. In some embodiments, user controls 171 may be integrated with display 178 as a touchscreen to operate as both user controls 171 and display 178. Logic device 170 may be configured to sense control input signals from user controls 171 and respond to sensed control input signals received therefrom. In some embodiments, portions of display 178 and/or user controls 171 may be implemented by appropriate portions of a tablet, a laptop computer, a desktop computer, and/or other types of devices.

In various embodiments, user controls 171 may be configured to include one or more other user-activated mechanisms to provide various other control operations of imaging system 100, such as auto-focus, menu enable and selection, field of view (FoV), brightness, contrast, gain, offset, spatial, temporal, and/or various other features and/or parameters.

Imaging system 100 may include various types of other sensors 180 including, for example, microphones, navigation sensors, temperature sensors, and/or other sensors as appropriate.

Logic device 170 may be configured to receive and pass images from imager interface 168 and signals and data from sensors 180, and/or user controls 171 to a host system and/or other external devices (e.g., remote systems) through communication interface 176 (e.g., through wired and/or wireless communications). In this regard, communication interface 176 may be implemented to provide wired communication over a cable and/or wireless communication over an antenna. For example, communication interface 176 may include one or more wired or wireless communication components, such as an Ethernet connection, a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components configured for communication with a network. As such, communication interface 176 may include an antenna coupled thereto for wireless communication purposes. In other embodiments, the communication interface 176 may be configured to interface with a DSL (e.g., Digital Subscriber Line) modem, a PSTN (Public Switched Telephone Network) modem, an Ethernet device, and/or various other types of wired and/or wireless network communication devices configured for communication with a network.

In some embodiments, a network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) configured to communicate with other communication networks, such as the Internet. As such, in various embodiments, imaging system 100 and/or its individual associated components may be associated with a particular network link such as for example a URL (Uniform Resource Locator), an IP (Internet Protocol) address, and/or a mobile phone number.

Imaging system 100 may include various other components 182 such as speakers, additional displays, visual indicators (e.g., recording indicators), vibration actuators, a battery or other power supply (e.g., rechargeable or otherwise), and/or additional components as appropriate for particular implementations.

Although various features of imaging system 100 are illustrated together in FIG. 1, any of the associated components and subcomponents may be implemented in a distributed manner and used remotely from each other as appropriate (e.g., through appropriate wired and/or wireless network communication).

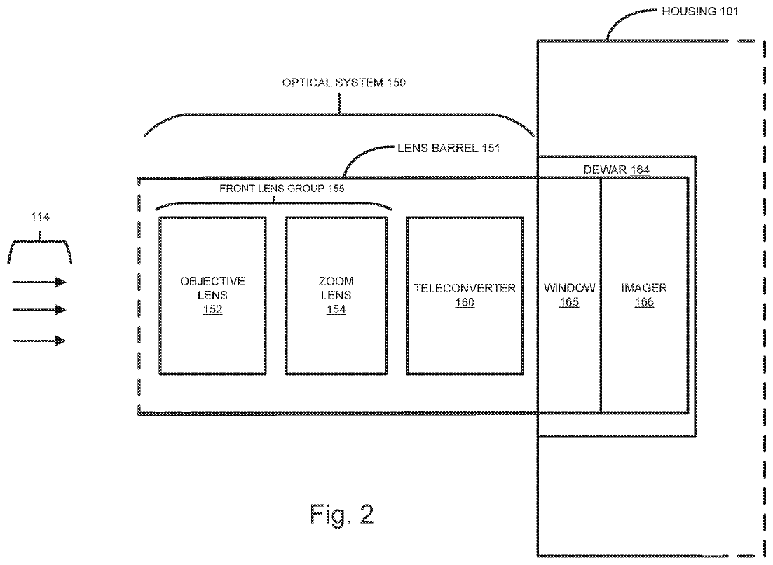

FIG. 2 illustrates a block diagram of optical system 150 in combination with other features in accordance with an embodiment of the disclosure. Optical system 150 is illustrated including a lens barrel 151 used to secure the various illustrated components disposed therein. It will be appreciated that lens barrel 151 is illustrated as a single continuous body merely for purposes of example. In this regard, the various components of optical system 150 may be selectively attached and detached from each other and housing 101 with or without lens barrel 151 in other embodiments.

Radiation 114 is received by optical system 150 and passes through an objective lens 152 that collects and passes radiation 114. A zoom lens 154 (e.g., a group of one or more lenses providing variable zoom) receives radiation 114 from objective lens 152 to provide a selectively magnified intermediate image. In various embodiments, zoom lens 154 may be implemented with one or more lenses and/or other optical elements that may be selectively adjusted (e.g., manually and/or by one or more actuators under the control of logic device 170) to increase an associated focal length. Together, objective lens 152 and zoom lens 154 provide a front lens group 155 of a re-imaging optical system 150 in relation to teleconverter 160.

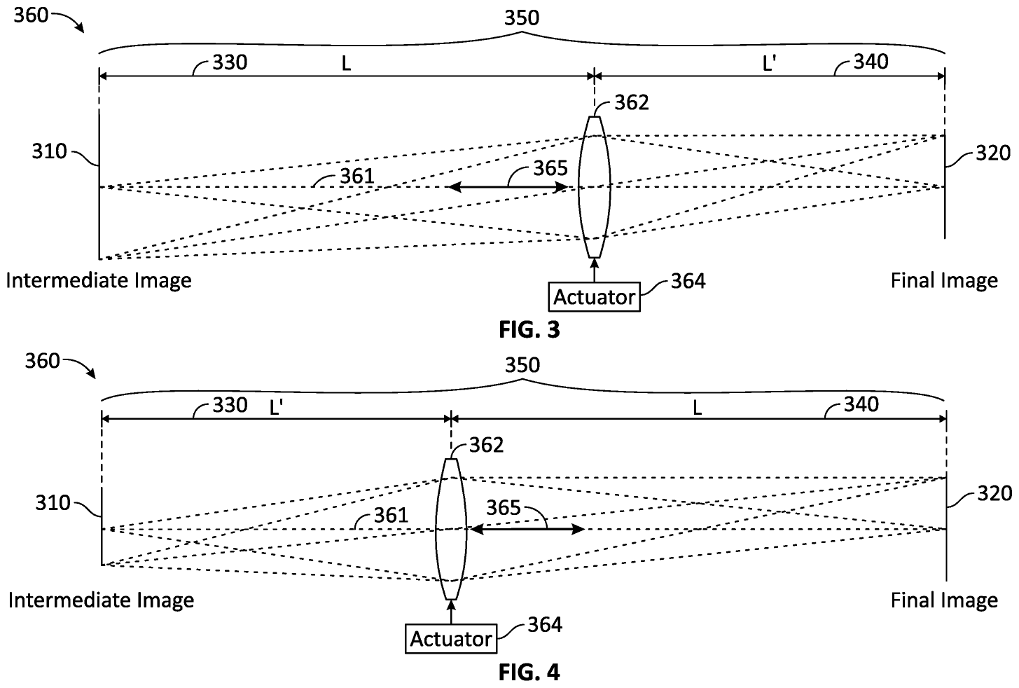

Teleconverter 160 receives the intermediate image of radiation 114 provided by front lens group 155 to provide a final image of radiation 114 that is captured by imager 166. Thus, it will be appreciated that teleconverter 160 operates as a relay lens group between front lens group 155 and imager 166. As previously noted and further discussed herein, teleconverter 160 may be selectively adjusted between a base lens configuration (e.g., providing no additional magnification) and one or more tele-lens configurations (e.g. providing additional magnification above that provided by zoom lens 154). In this regard, teleconverter 160 may include one or more lenses that may be selectively adjusted (e.g., axially shifted) along an optical axis of optical system 150 (e.g., manually and/or by one or more actuators under the control of logic device 170) to increase an associated focal length. Further details of various embodiments of teleconverter 160 are provided in FIGS. 3 to 10 discussed herein.

FIG. 3 illustrates an embodiment 360 of teleconverter 160 with a relay lens group comprising a single lens 362 in a base configuration. In some embodiments, lens 362 may be a group of lenses. Teleconverter 360 receives an intermediate image (e.g., a first image) at an intermediate image plane 310 from zoom lens 154 and provides a final image (e.g., a second image) at a final image plane 320 for capture by imager 166 as discussed.

In FIG. 3, lens 362 is in a base lens configuration with a distance 330 from intermediate image plane 310 corresponding to a length L (e.g., a front focal length), a distance 340 from final image plane 320 corresponding to a length L′ (e.g., a rear focal length), and a distance 350 (e.g., total track length) between intermediate image plane 310 and final image plane 320 of length L+L′. As such, the magnification provided by teleconverter 360 from intermediate image plane 310 to final image plane 320 in the base configuration of FIG. 3 will be L′/L.

FIG. 4 illustrates teleconverter 360 with lens 362 in a magnified configuration in accordance with an embodiment of the disclosure. In FIG. 4, lens 362 is in a second position (e.g. a second orientation) corresponding to an adjusted lens configuration with distance 330 now corresponding to length L′, distance 340 corresponding to length L, and distance 350 still maintained at length L+L′. As such, the magnification provided by teleconverter 360 from intermediate image plane 310 to final image plane 320 in the magnified configuration of FIG. 4 will be L/L′.

In view of the above, it will be appreciated that teleconverter 360 may provide selective magnification while maintaining an overall size (e.g., distance 350) identical to a base relay lens group (e.g., providing a (L/L′)\hat{ }2 teleconverter). By shifting the relay lens group (e.g., lens 362), the conjugate ratio between the intermediate image at intermediate image plane 310 and the final image at final image plane 320 changes (e.g., resulting in selective magnification) while the positions of intermediate image plane 310 and final image plane 320 remain unchanged.

In some embodiments, lens 362 may be at a fixed position within teleconverter 360. In such cases, at least a portion of teleconverter 360 including lens 362 (e.g., and/or additional lenses collectively providing a group of lenses in some embodiments) or the entirety of teleconverter 360 may be reversed (e.g., flipped) in relation to front lens group 155 to selectively provide either the base configuration of FIG. 3 or the magnified configuration of FIG. 4. In other embodiments, lens 362 may be selectively shifted axially along an optical axis 361 of teleconverter 360 and optical system 150 in the directions noted by double headed arrow 365 (e.g., manually and/or by one or more actuators 364 under the control of logic device 170) to position lens 362 in accordance with the base configuration of FIG. 3, the magnified configuration of FIG. 4, and/or intermediate positions in between.

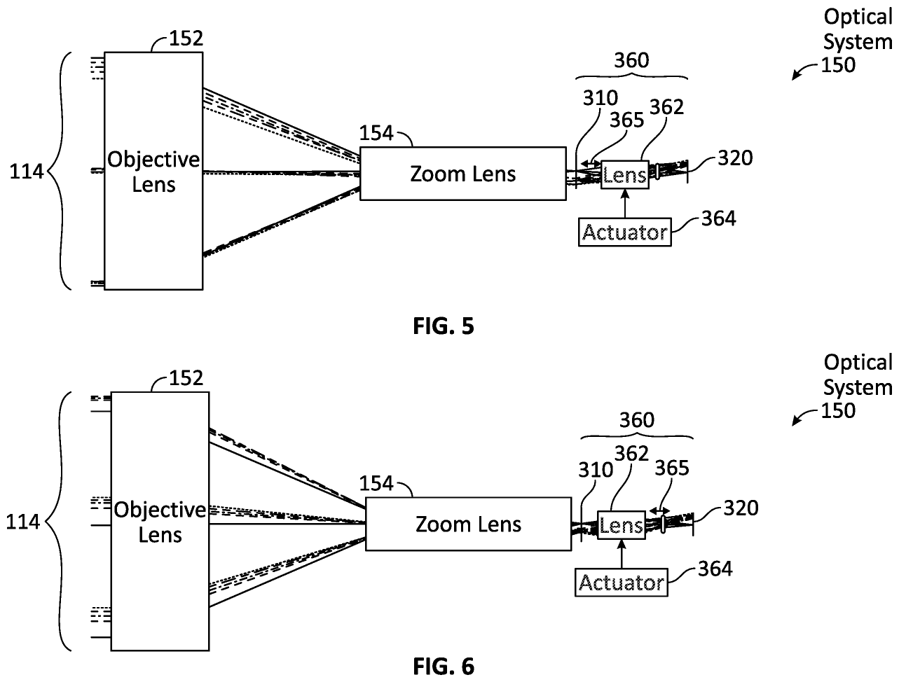

FIGS. 5 and 6 illustrate example implementations of teleconverter 360 in the configurations of FIGS. 3 and 4, respectively, in the context of optical system 150 in accordance with embodiments of the disclosure. Lens barrel 151 is omitted from FIGS. 5 and 6 for ease of illustration. As shown, lens 362 may be selectively positioned in relation to intermediate image plane 310 and final image plane 320 to provide different magnification in response to radiation 114 received from objective lens 152 and zoom lens 154.

For example, if zoom lens 154 provides a continuous zoom range of f1 to f2 and teleconverter 360 provides a magnification change of M between the base and magnified configurations, then optical system 150 may provide a continuous zoom range of f1 to f2 in FIG. 5 and a continuous zoom range of M×f1 to M×f2 in FIG. 6.

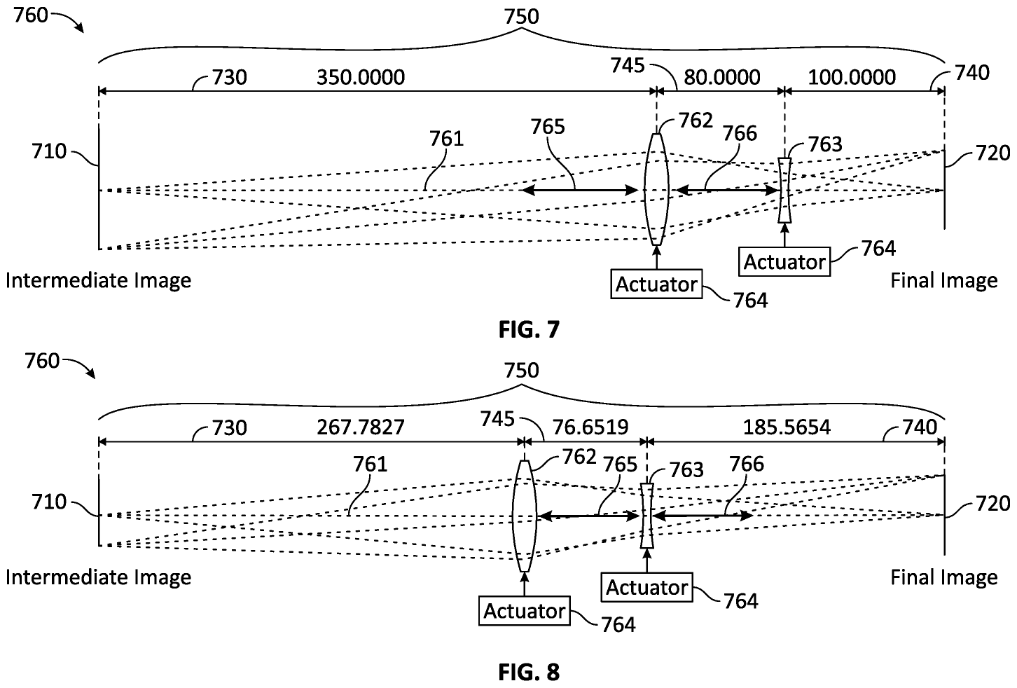

FIG. 7 illustrates an embodiment 760 of teleconverter 160 with a relay lens group comprising multiple lenses 762 and 763 in a base configuration. Teleconverter 760 receives an intermediate image (e.g., a first image) at an intermediate image plane 710 from zoom lens 154 and provides a final image (e.g., a second image) at a final image plane 720 for capture by imager 166 as discussed.

In FIG. 7, lenses 762 and 763 are in a base lens configuration with a distance 730 from intermediate image plane 710 to lens 762 corresponding to a distance 350, a distance 740 from lens 763 to final image plane 720 corresponding to a length 100, a distance 745 between lenses 762 and 763 corresponding to a length 80, and a distance 750 (e.g., total track length) between intermediate image plane 710 and final image plane 720 of length 530. In this example, lens 762 has a focal length of 100 and lens 763 has a focal length of 150. In this base lens configuration, teleconverter 760 provides a magnification of 2/3 from intermediate image plane 710 to final image plane 720.

FIG. 8 illustrates teleconverter 760 with lenses 762 and 763 in a magnified configuration in accordance with an embodiment of the disclosure. In particular, lenses 762 and 763 are in an adjusted lens configuration with distance 730 now corresponding to length 267.7827, distance 740 corresponding to length 185.5654, distance 745 corresponding to length 76.6519, and distance 750 still maintained at length 530. In this adjusted lens configuration, teleconverter 760 provides a magnification of 4/3 from intermediate image plane 710 to final image plane 720.

Upon comparison of FIGS. 7 and 8, it will be appreciated that lenses 762 and 763 have each been shifted (e.g., translated) by different lengths along an optical axis 761 of teleconverter 760 and optical system 150 in the directions noted by double headed arrows 765 and 766, respectively. In various embodiments, this shifting may be performed (e.g., manually and/or by one or more actuators 764 under the control of logic device 170) to position lenses 762 and 763 in accordance with the base configuration of FIG. 7, the magnified configuration of FIG. 8, and/or intermediate positions in between.

By providing two or more adjustable lenses 762 and 763, teleconverter 760 may be used to provide optical system designers and users with additional options and degrees of freedom for providing desired magnification with increased flexibility (e.g., reduced sizes and costs associated with the various components and ray heights of optical system 150) over the single lens implementation of teleconverter 360.

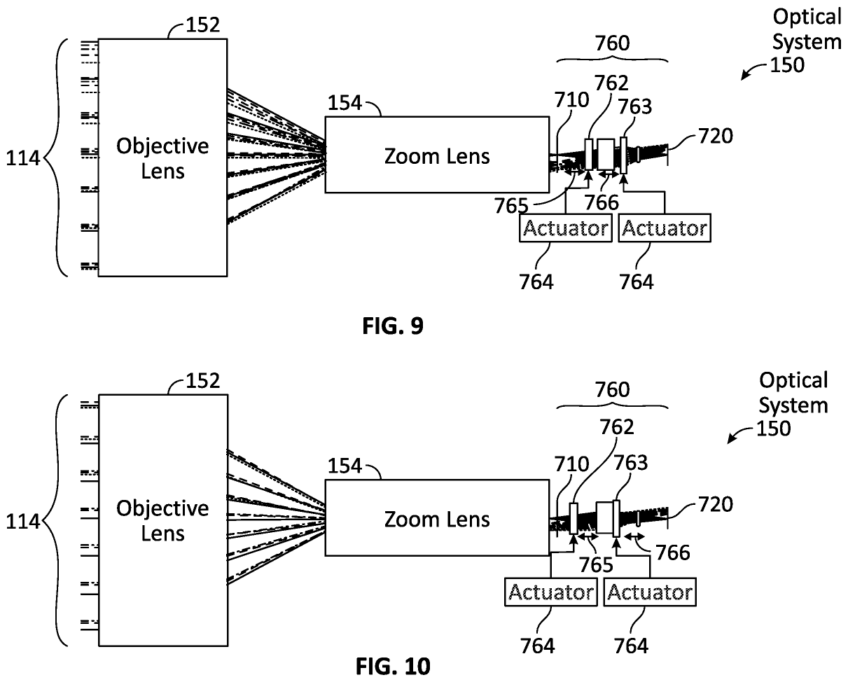

FIGS. 9 and 10 illustrate example implementations of teleconverter 760 in the configurations of FIGS. 7 and 8, respectively, in the context of optical system 150 in accordance with embodiments of the disclosure. Lens barrel 151 is omitted from FIGS. 9 and 10 for ease of illustration. As shown, lenses 762 and 763 may be selectively positioned in relation to intermediate image plane 710 and final image plane 720 to provide different magnification in response to radiation 114 received from objective lens 152 and zoom lens 154.

For example, as similarly discussed with regard to FIGS. 5 and 6, if zoom lens 154 provides a continuous zoom range of f1 to f2 and teleconverter 760 provides a magnification change of M between the base and magnified configurations, then optical system 150 may provide a continuous zoom range of f1 to f2 in FIG. 9 and a continuous zoom range of M×f1 to M×f2 in FIG. 10.

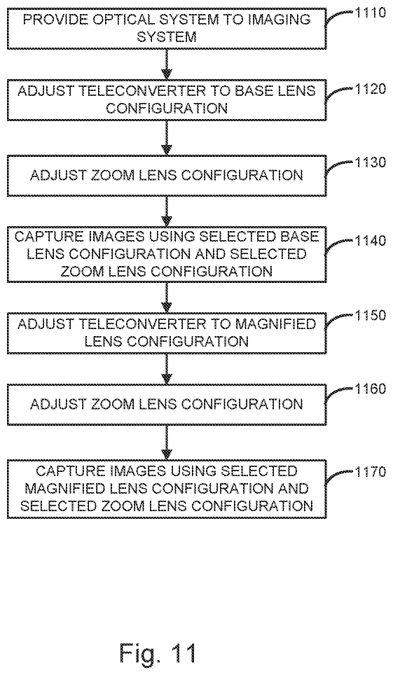

FIG. 11 illustrates a process of operating imaging system 100 with teleconverter 160 in accordance with an embodiment of the disclosure. In block 1110, optical system 150 is provided to imaging system 100. For example, in some embodiments, optical system 150 may be provided as a lens barrel 151 that may be selectively attached to housing 101 of imaging system 100. In this regard, block 1110, may also include securing front lens group 155 and teleconverter 160 by lens barrel 151. In other embodiments, optical system 150 may be permanently attached to imaging system 100 during manufacture.

In block 1120, teleconverter 160 is adjusted to a base lens configuration. For the embodiment 360 with lens 362 (e.g., and/or additional lenses collectively providing a group of lenses in some embodiments), block 1120 may include installing teleconverter 360 in the fixed orientation shown in FIG. 3 or axially shifting lens 362 to such orientation as discussed. For the embodiment 760 with lenses 762 and 763, block 1120 may include axially shifting lenses 762 and 763 to such orientation as discussed.

In block 1130, zoom lens 154 is adjusted to provide a desired magnification (e.g., manually and/or by one or more actuators under the control of logic device 170 as discussed). Thus, following block 1130, optical system 150 will be configured to provide a selected magnification determined by zoom lens 154 and a base lens configuration.

In block 1140, imager 166 captures one or more images (e.g., thermal images) of scene 110 using the selected base lens configuration and the selected zoom lens configuration. In embodiments where imager 166 is a thermal imager provided in a dewar 164 (e.g., as shown in FIG. 1), block 1140 may further include maintaining imager 166 at a specified temperature by dewar 164.

In block 1150, teleconverter 160 is adjusted to a magnified lens configuration. For the embodiment 360 with lens 362 (e.g., and/or additional lenses collectively providing a group of lenses in some embodiments), block 1150 may include removing, reversing (e.g., flipping), and re-installing at least a portion or an entirety of teleconverter 360 in the fixed orientation shown in FIG. 4 or axially shifting lens 362 to such orientation as discussed. For the embodiment 760 with lenses 762 and 763, block 1120 may include axially shifting lenses 762 and 763 to such orientation as discussed.

In block 1160, zoom lens 154 is adjusted to provide a desired magnification (e.g., manually and/or by one or more actuators under the control of logic device 170 as discussed). Thus, following block 1160, optical system 150 will be configured to provide a selected magnification determined by zoom lens 154 and a magnified lens configuration. As discussed, such configuration may provide additional magnification than would otherwise be available using zoom lens 154 alone.

In block 1170, imager 166 captures one or more images (e.g., thermal images) of scene 110 using the selected magnified lens configuration and the selected zoom lens configuration. In some embodiments, block 1170 may further include maintaining imager 166 at a specified temperature by dewar 164 as discussed.

It will be appreciated that the various blocks of FIG. 11 may be repeated, reordered, and/or modified as appropriate to operate imaging system 100 with a variety of lens configurations to capture desired images of scene 110 using various combinations of magnification provided by zoom lens 154 and/or teleconverter 160.

In view of the present disclosure, it will be appreciated that the implementation of teleconverters in accordance with the various embodiments provided herein may be used to provide selectable magnification to imaging systems in a compact, efficient, and cost effective manner with reduced numbers of optical and mechanical parts. Additional savings may also be realized from the tolerances, alignment, and reliability associated with such embodiments. Moreover, testing of the various disclosed embodiments has provided practical performance yielding diffraction-limited or near diffraction-limited results. In addition, the various embodiments discussed herein can facilitate the addition of teleconverters to thermal imaging systems with cooled imagers and zoom lenses in a manner that would otherwise be practical.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A system comprising:
a front lens group configured to form a first image at an intermediate image plane in response to radiation from a scene;
a teleconverter configured to project the first image to form a second image at a final image plane; and
wherein the teleconverter comprises a relay lens group configured to be selectively positioned between the intermediate image plane and the final image plane to adjust a magnification of the second image.

2. The system of claim 1, wherein the relay lens group comprises one or more lenses configured to be selectively reversed in relation to the front lens group to adjust positions of the one or more lenses between the intermediate image plane and the final image plane.

3. The system of claim 1, wherein the relay lens group comprises one or more lenses configured to be axially shifted along an optical axis to adjust their respective positions between the intermediate image plane and the final image plane.

4. The system of claim 3, wherein the lenses are configured to be axially shifted by different lengths in relation to each other.

5. The system of claim 1, further comprising an actuator configured to adjust a position of the relay lens group between the intermediate image plane and the final image plane.

6. The system of claim 1, wherein the front lens group comprises:
an objective lens configured to pass the radiation from the scene; and
a zoom lens configured to form the first image in response to the radiation passed by the objective lens.

7. The system of claim 1, further comprising an imager configured to capture the second image.

8. The system of claim 7, wherein the imager is a thermal imager and the system is a thermal imaging camera, wherein the teleconverter is configured to be selectively attached to the thermal imaging camera.

9. The system of claim 8, further comprising a dewar configured to maintain the thermal imager at a specified temperature.

10. The system of claim 1, further comprising a lens barrel configured to secure the front lens group and the teleconverter.

11. A method comprising:
forming, by a front lens group, a first image at an intermediate image plane in response to radiation from a scene;
projecting, by a teleconverter, the first image to form a second image at a final image plane; and
selectively positioning a relay lens group of the teleconverter between the intermediate image plane and the final image plane to adjust a magnification of the second image.

12. The method of claim 11, wherein the relay lens group comprises one or more lenses, wherein the positioning comprises selectively reversing the one or more lenses to adjust positions of the one or more lenses between the intermediate image plane and the final image plane.

13. The method of claim 11, wherein the relay lens group comprises one or more lenses, wherein the positioning comprises axially shifting the one or more lenses along an optical axis to adjust their respective positions between the intermediate image plane and the final image plane.

14. The method of claim 13, wherein the lenses are configured to be axially shifted by different lengths in relation to each other.

15. The method of claim 11, wherein the positioning is performed by an actuator.

16. The method of claim 11, wherein the front lens group comprises an objective lens and a zoom lens, wherein the method further comprises:
passing, by the objective lens, the radiation from the scene; and
forming, by the zoom lens, the first image in response to the radiation passed by the objective lens.

17. The method of claim 11, further comprising capturing the second image by an imager.

18. The method of claim 17, wherein the imager is a thermal imager of a thermal imaging camera, the method further comprising attaching the teleconverter to the thermal imaging camera.

19. The method of claim 18, further comprising maintaining the thermal imager at a specified temperature by a dewar of the thermal imaging camera.

20. The method of claim 11, further comprising securing the front lens group and the teleconverter by a lens barrel.
